(19) United States
(12) Patent Application Publication
(10) Pub. No.: US 2025/0157074 A1
(43) Pub. Date: May 15, 2025

(54) Systems and Methods for Virtual and Real-World Positioning and Locationing

(71) Applicant: ADAM PERRY LIMITED COMPANY, Bixby, OK (US)

(72) Inventor: Adam Gobbo, Bixby, OK (US)

(21) Appl. No.: 18/727,240

(22) PCT Filed: Aug. 1, 2023
(86) PCT No.: PCT/US2023/029161

§ 371 Date: Jul. 8, 2024

Related U.S. Application Data
(60) Provisional application No. 63/370,016, filed on Aug. 1, 2022.

(51) Int. Cl. G06T 7/73; G01C 21/00

(52) U.S. Cl. CPC G06T 7/73; G01C 21/3811

(57) ABSTRACT

A universal, optimized database is described that includes a scalable framework having an earth centered, earth fixed (ECEF) origin so that data and locations can be accurately referenced for algorithm processing and visual depiction. The universal, optimized database may be referred to as a tesseract-based coordinate space. The tesseract-based coordinate space integrates position, size, attributes, and time for contextual analysis. Application of the present invention includes navigation systems and methods and/or database fidelity for locationing, positioning, and/or trend analysis. The tesseract-based coordinate space may comprise off-line calculations, which are later added to other shapes (e.g., cubes) that may be part of a time series.

### RELATED APPLICATION

This application claims the benefit of U.S. Provisional Application No. 63/370,016 (filed on Aug. 1, 2022), which is incorporated in its entirety by reference herein.

### FIELD OF THE DISCLOSURE

The present invention is related to virtual and real-world positioning and locationing systems and methods, and more particularly, to virtual and real-world positioning and locationing systems and methods for integrating, and using, for example, a new point of origin, and a scalable earth-centered, earth-fixed (ECEF) coordinate space accessed by computing instructions for providing positioning shape-based locationing, positioning, and/or timing of shapes, which may represent objects or otherwise locations, within the ECEF coordinate space.

### BACKGROUND

A location or place may be defined by a point, line, or area, e.g., between two or more point-based locations that form a segment or area or multiple segments or areas. Descriptive locality defines an area with or without boundaries, but that are used to describe the overall area, i.e., the Los Angles Metro area. Relative location is similar to military polar missions, which describe a shift or displacement from one site to another using range, i.e. three miles south of the intersection. Absolute location can be designated using a specific pairing of latitude and longitude in a Cartesian coordinate grid (for example, a spherical coordinate system or an ellipsoid-based system such as the World Geodetic System) or similar methods.

There are three main types of navigation: celestial, Global Position Systems (GPS), and map and compass. With development of GPS, and the use of known latitude and longitudinal descriptors, navigation has become commonplace in most devices. For example, the current U.S. GPS system uses twenty-four or more satellites orbing the earth at approximately 20,200 miles. Using six orbits each satellite orbits the earth twice a day. All GPS satellites broadcast on at least two carrier frequencies: L1, at 1575.42 MHz, and L2, at 1227.6 MHz (newer satellites also broadcast on L5 at 1176 MHz). The GPS system provides absolute location but with an error of approximately 1.82 to 4.9 meters and 95% of the time. Real Time Kinematic (RTK) GPS uses a base station can provide up to 1-2 centimeter accuracy.

Currently, quantitative data and information from conventional sources such as LiDAR, SAR, photogrammetry, electromagnetic emissions are unable to, in a same dataset, associate a qualitative a location. This is so, even if RTK may be used to somehow quantify the size of an emission/propagation or value relative to other datasets in a world's current location framework. That is, data received from multiple data sources creates a problem because coordinating or correlating multiple data sources, especially in real-time or near real-time, and is difficult. In particular, the assumption of location decouples the context of the data, coming from multiple data sources, in the same way a street address decouples all the information about the house, property, occupants, etc.

In view of this, there is a need for systems and methods to measure distance between data sources instead of disparate location in insolation from the data attributes and/or descriptors, that overcomes the aforementioned limitations in the prior art.

### SUMMARY

In various aspects, virtual and real-world positioning and locationing system(s) and/or method(s) described herein my comprise one or more controller(s) (e.g., processor(s) as executing on one or more servers or cloud platform(s)) and one or more computer memories storing computing instructions for implementing algorithms or methods for virtual and/or real-world positioning and locationing by use of a scalable earth-centered, earth-fixed (ECEF) coordinate to an origin cube based algorithm to provide location of data and time series information in four dimensional space. The virtual and real-world positioning and locationing system(s) and/or method(s) may generate, receive, and/or store positioning and locationing data or information or database in a database or, more generally, computer memory, and may access such data or information therefrom. The systems and methods described here are configured to create, store, and/or provide high quality or high fidelity location or position information or data in real-time or near real-time.

The present invention may comprise, or take the form of, systems and/or methods for determining the measurement of absolute locations using a scalable origin (e.g., comprising a shape, such as a cube) and an ECEF designed framework.

In accordance with the disclosure herein, the present disclosure includes improvements in computer functionality or in improvements to other technologies at least because the disclosure recites, e.g., a computationally efficient platform for locationing and positioning within a single coordinate space (e.g., tesseract-based space). That is, the present disclosure describes improvements in the functioning of the computer itself or “any other technology or technical field” because the virtual and real-world positioning and locationing system(s) and/or method(s) described herein are configured to aggregate and ingest data and provide an accurate and single source or position-and-temporal coordinated database, or otherwise memory store, for determining virtual and real-world positioning or locationing of shapes, shapes (e.g., cubes) that may defined objects within coordinate space. This improves over the prior art at least because the single source database or otherwise memory store reduces computer memory and storage required by conventional redundant systems that may store the same information in various ways and in different or incompatible formats. In addition, conventional systems typically lack data fidelity where the different and/or redundant systems are unable to, or not configured, to coordinate in order to streamline data, such as time series of data, for locationing and/or positioning in a given coordinate space in real-time or near-real time.

In addition, the present disclosure includes effecting a transformation or reduction of a particular article to a different state or thing, e.g., locationing and/or position data in the real world in transformed or reduced into space-based (e.g., tesseract based) information defining attributes and/or features in four dimensions.

Still further, the present disclosure includes specific features other than what is well-understood, routine, conventional activity in the field, and/or otherwise add unconventional steps that confine the disclosure to a particular useful application, e.g., virtual and real-world positioning and locationing system(s) as described herein.

Advantages will become more apparent to those of ordinary skill in the art from the following description of the preferred aspects that have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates a computer-implemented system and related method for generating and accessing a coordinate space (e.g., a tesseract-based space) in accordance with various embodiments disclosed herein.

FIG. 2 illustrates an example coordinate space (e.g., a tesseract-based space) in accordance with various embodiments disclosed herein.

FIG. 3 illustrates scaling of locations within the coordinate space (e.g., a tesseract-based space) of FIGS. 1 and 2 in accordance with various embodiments disclosed herein.

FIG. 4 illustrates mapping of shapes and location information within the coordinate space (e.g., a tesseract-based space) of FIGS. 1 and 2 in accordance with various embodiments disclosed herein.

FIG. 5 illustrates a plurality of shapes (e.g., cubes) defining an object (e.g., a vehicle) within the coordinate space (e.g., a tesseract-based space) of FIG. 2, in accordance with various embodiments disclosed herein.

FIG. 6 illustrates an example aspect of positioning and locationing within the coordinate space (e.g., a tesseract-based space) of FIG. 2 based on two-dimensional images captured in the real-world, in accordance with various embodiments disclosed herein.

The Figures depict preferred embodiments for purposes of illustration only. Alternative embodiments of the systems and methods illustrated herein may be employed without departing from the principles of the invention described herein.

### DESCRIPTION

In various aspects, virtual and real-world positioning and locationing system(s) and/or method(s) described herein my comprise one or more controller(s) (e.g., processor(s) as executing on one or more servers or cloud platform(s)), and one or more computer memories, storing computing instructions for implementing algorithms or methods for virtual and/or real-world positioning and locationing by use of a scalable earth-centered, earth-fixed (ECEF) coordinate to an origin cube based algorithm providing location of data and time series. The virtual and real-world positioning and locationing system(s) and/or method(s) may store positioning and locationing data or information or database in a database or, more generally, computer memory, and may access such data or information therefrom. The memory may comprise tangible, non-transitory computer-readable medium storing instructions for generating location specific data and/or for performing any other algorithms, methods, or functions as described herein.

In various aspects, the computing instructions, when executed by the controller, may further cause the controller executing virtual and real-world positioning and locationing system(s) and/or method(s), to translate latitude, longitude, elevation into tesseract based XYZ coordinates having temporal or time data. In addition, in some aspects, the computing instructions, when executed by the controller, may further cause the extraction or determination of data, features, or attributes for associating with given shapes into coordinate space (e.g., a coordinate space based on tesseract locationing or positioning). This may comprise, for example, ingestion or coordination of information, data, features, and/or attributes for instantiation of multiple partial or full shapes (e.g., cubes) within the coordinate space (e.g., tesseract-based space), and having such information, data, features, and/or attributes, in order to achieve data integrity and/or alignment for multiple time series of data. Additionally, or alternatively, this may further include accessing information, from the system, for the determination, locationing, or positioning of partial or full shapes (e.g., tesseracts) into a coordinate space.

Still further, in additional aspects, the present invention may comprise, or take the form of, systems and/or methods for determining the measurement of absolute locations using a scalable origin (e.g., comprising a shape, such as a cube) and ECEF designed framework, comprising a controller, executing computing instructions, configured to receive contextual information containing location data.

The computing instructions, when executed by the controller, may further cause the controller to determine a corresponding tesseract location or position of a tesseract coordinate area. A given tesseract location be defined by, or may otherwise be associated with, a shape (e.g., a cube). More generally, a tesseract location may define a four-dimensional shape comprising three-dimensional shape coordinates (e.g., X, Y, and Z dimension coordinates) in addition to a time or otherwise temporal coordinate defining one or more features or attributes of the space at the three-dimensional shape coordinates, such as at a given point in time. In various aspects, the given point in time may be measured at one or more frequencies (e.g., one measurement or reading per second, one measurement or reading per millisecond, or the like).

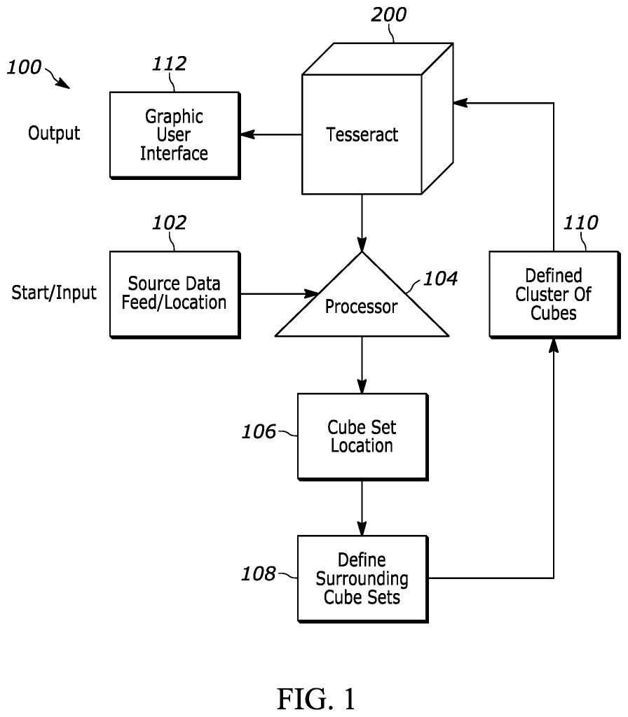

FIG. 1 illustrates a computer-implemented system and related method 100 for generating and accessing a coordinate space (e.g., a tesseract-based space) in accordance with various embodiments disclosed herein. For example, the computer-implemented system and related method 100 comprises a computing system configured to generate shape-related data for positioning and locationing of shapes (e.g., cubes), which may define objects and/or locations, within a coordinate space (e.g., a tesseract-based space). The computer-implemented system comprises a controller (e.g., processor 104), a memory (not shown), and a database communicatively coupled to the controller (e.g., processor 104).

The memory can store computing constructions that when executed by the controller, causes the controller to (at block 102) receive input data from a sensor or other data source, where the input data comprises location or positioning information. In various aspects, the locating or positioning information may be stored in a database.

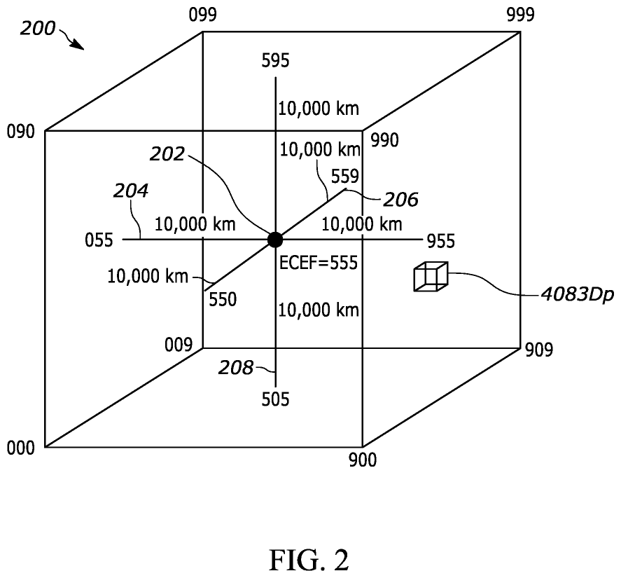

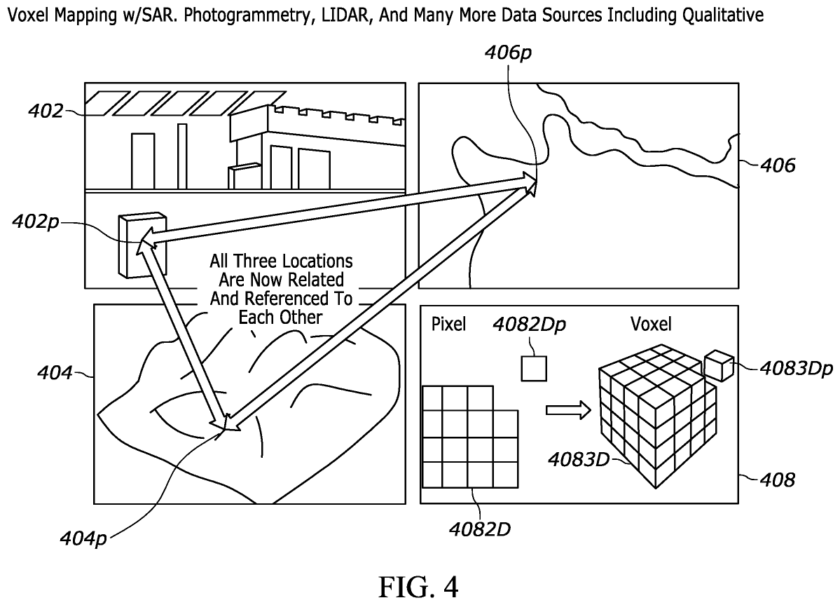

The computing constructions, when executed by the controller, may further cause the controller (at block 106) to set or map the locating or positioning information to a four dimensional coordinate space (e.g., a tesseract-based space), for example, as shown by tesseract 200, and as further described herein for FIGS. 2-4. Setting or mapping the locating or positioning information may comprise defining surrounding cube sets or clusters (or otherwise decomposing an object into a sub-set of clustered cubes), for example, as described for FIG. 4. At block 110 the cube sets or clusters of cubes (e.g., making up a defined object) may be positioned, located, assigned, or otherwise defined within coordinate space 200 (e.g., a tesseract-based space).

At block 112, the computing constructions, when executed by the controller, may further cause the controller to display one or more locations, position, or related information on a graphic user interface (GUI). Additionally, or alternatively, the coordinate space 200 (e.g., a tesseract-based space), for example, a tesseract graphic or representation, may be displayed.

FIG. 2 illustrates an example coordinate space 200 (e.g., a tesseract-based space) in accordance with various embodiments disclosed herein. In various aspects, coordinate space 200 is a cube shaped space. In some aspects, coordinate space 200 is defined by dimensions of the earth, including an equator or latitude 204 dimension, a prime meridian or latitude dimension 206, and a north-south pole dimension 208. Coordinate space 200 may have an origin point 202, which may be defined by a zero point (on a zero-point X-Y-Z coordinate scale) or, additionally or alternatively, an ECEF mid-point at value 555 (on a scale 000-999 as defined each of the three dimensions as shown for FIG. 2). Coordinate space 200 may comprise a tesseract-based coordinate space because one or more values or points therein may be associated with a time value and related features and/or attributes defining properties of shape (e.g., cube), which may define one or more objects existing at that point, or within that space, at the given time. In this way, the coordinate space 200 is referred to herein as a four-dimensional or tesseract-based coordinate space.

The coordinate space 200 may be generated, mapped, prepared, or accessed in various manners. For example, a controller, e.g., processor 104 as described for FIG. 1, may execute computing instructions to set or map locating or positioning information relative to a point of origin and/or earth center, earth fixed point (e.g., origin point 202) of coordinate space 200, which is a four dimensional coordinate space.

Once mapped or set, a controller, e.g., processor 104 as described for FIG. 1, may execute computing instructions to generate or determine locationing or positioning data (e.g., latitude information or longitude information) of a shape or voxel (as shown and described for FIG. 4). In various aspects, a shape or voxel may have a location derived from, or assigned to, a location or position within coordinate space 200 (e.g., a tesseract-based space). The shape or voxel location may be derived from, or be based on, a point of origin (e.g., a point having a value of XYZ=000 and/or ECEF value of 555) of the coordinate space 200.

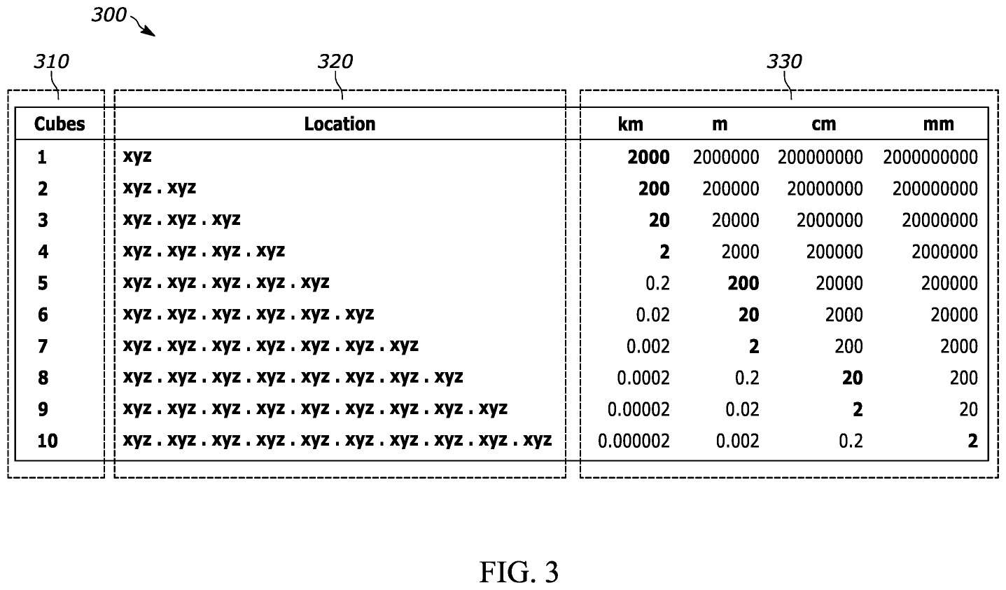

FIG. 3 illustrates scaling of locations or positions within the coordinate space 200 (e.g., a tesseract-based space) of FIGS. 1 and 2 in accordance with various embodiments disclosed herein. FIG. 3 illustrates an example data table 300 showing example cubes 310 (1-10) each having a related location 320 and granularity measurement 330 within coordinate space 200. The locations “xyz” and “xyz.xyz,” and so forth, each represent a unique and granular location. For example, cube 1 has a least granular location at position or location XYZ in coordinate space 200, where the granularity of cube 1 has a measurement at the kilometer (k) level (e.g., 2000 kilometers in the example of FIG. 3). As a further example, cube 5 has a more granular location at position or location “xyz.xyz.xyz.xyz.xyz” in coordinate space 200, where the granularity of cube 5 has a measurement at the meter (m) level (e.g., 200 meters in the example of FIG. 3). In the example of FIG. 3, cube 5 is located within cube 1 and its greater degree of granularity gives a more precise location within coordinate space 200 (e.g., a tesseract-based space). Other combinations of granularity and cube relationships are possible, for example, as shown for FIG. 3. Additionally, each cube or otherwise shape can be provided with its position information based on position information from an adjacent cube or shape. In this way, all (or least a subset of) cubes or shapes in the coordinate space 200 (e.g., a tesseract-based space) can be instantiated with a location or position based on a single cube's location or position. For example, all (or at least a subset of) cubes or shapes in the coordinate space 200 (e.g., a tesseract-based space) may be instantiated with a location or position based on the ECEF mid-point at value 555 location.

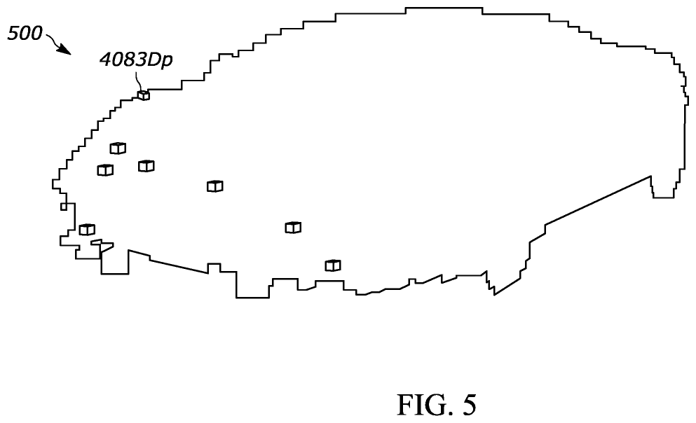

In this way, in various aspects coordinate space 200 (e.g., shaped as a cube) may comprise one or more degrees of granularity measurements 330 that require corresponding granular locations 320. For example, in various aspects, one given shape (e.g., a cube), for example cube 1 of cubes 310, itself may be comprised of multiple tesseract shapes (e.g., any one or more of cubes 2-10), each having their own precise locations. Said another way, one cube (e.g., cube 1 of cubes 310) may be comprised of several smaller cubes, each having their own respective, more precise tesseract location(s) within a predefined coordinate space. In various aspects, the controller (e.g., processor 104), executing computing instructions, may decompose or otherwise determine a shape (e.g., a cube based shape, see, for example FIG. 5) within a given environment or coordinate space into smaller scaled shapes in order to generate a cluster of shapes (e.g., voxels), which in turn may be used to visually represent a larger shape or object representative of contextual data within the environment or coordinate space. Said another way, a cluster of shapes (e.g., cubes 2-10 of cubs 310) may be added to an environment or coordinate space (e.g., a tesseract based coordinate space 200) to define a larger object (e.g., cube 1). Moreover, each shape (e.g., any of cubes 1-10) may be associated with a time at which a feature, attribute, or otherwise contextual data associated with the shape, at given position and/or location, is detected. Said another way, each shape (e.g., cube or voxel) may be defined by a time data defining contextual information, feature(s), or attribute(s) was placed in the tesseract coordinate space.

FIG. 4 illustrates mapping of shapes and location information within the coordinate space 200 (e.g., a tesseract-based space) of FIGS. 1 and 2 in accordance with various embodiments disclosed herein. As shown for FIG. 4, various data sources may be use. Data from the data sources may be ingested as input sources to substantiate or add or otherwise associate features, attributes, or other information into coordinate space 200. The data sources may include, by way of non-limiting example, LiDAR image(s) (e.g., LiDAR image 402), photogrammetry (e.g., photogrammetry image 404), and synthetic-aperture radar (SAR) image(s) (e.g., SAR image 406). The images may each comprise pixel 4082D (2D) and/or voxel 4083D (3D) information. The pixel and voxel information may be analyzed and merged, coordinated, or otherwise normalized, across one or more of the images, to identify specific matching or correlated points, e.g., points 402p, 404p, 406p, 4082Dp, 4083Dp, etc. as shown for FIG. 4. Each point may be associated with features, data, or other attributes, as learned from or taken from a respective image, and such features, data, or other attributes may be added or merged into coordinate space 200 at the same position or location indicated or identified in in the various images (e.g., LiDAR image 402, photogrammetry image 404, SAR image 406).

In various aspects, the location of the shape or voxel within coordinate space 200 is determined by a confidence or range (e.g., a level of granularity as shown for FIG. 3) configured for a plurality of shapes or voxels of the coordinate space 200. The confidence or range may be based on the size and/or number of shapes and/or voxels (e.g., number of cubes) for the coordinate space (e.g., as shown for FIG. 3).

In still further aspects, a controller (e.g., processor 104) may store information assigned to a defined shape (e.g., a cube such as cube 1 of FIG. 3 or sub-voxel 4083Dp, which is a more granular voxel or otherwise point of voxel 4083D of FIG. 4) having a location within a coordinate space 200. Additionally, or alternatively, the defined shape may be further defined by a cluster of a plurality of sub-shapes (e.g., any one of cubes 2-10 of FIG. 3) configured to scale to fit a perimeter or outline of the defined shape within coordinate space 200. Still further, the a controller may assign a timestamp to the defined shape and/or one or more of the sub-shapes across one or more periods of time associated with a fourth dimension of the coordinate space 200.

In addition, a controller (e.g., processor 104) executing computer-readable medium storing instructions for generating location specific data may translate or assign input data having a location, timestamp, and/or other attribute to a shape located within a four dimensional coordinate space 200 (e.g., a tesseract-based space). By associating one or more of the shapes with relevant information, each of the one or more shapes, either alone or collectively, provides information about one or more related shape(s) and/or object(s) in the coordinate space 200, where shapes make up or at least correspond to the shape(s) and/or object(s) in coordinate space 200.

FIG. 5 illustrates a plurality of shapes (e.g., cubes) defining an object (e.g., a vehicle 500) within the coordinate space 200 (e.g., a tesseract-based space) of FIG. 2, in accordance with various embodiments disclosed herein. FIG. 5, by way of non-limiting example, illustrates a shape (e.g., a vehicle 500) that may comprise, may be decomposed into, and/or may otherwise be determined as a cube based shape (e.g., the vehicle 500) within a given environment or coordinate space (e.g., a tesseract based coordinate space 200). As shown for FIG. 5, the vehicle 500 comprises smaller scaled shapes in order to generate a cluster of shapes (e.g., voxels), which in turn may be used to visually represent a larger shape or object representative of contextual data within the environment or coordinate space (e.g., a tesseract based coordinate space 200). In this way, the vehicle 500 may be comprised of hundreds, thousands, or even more shapes (e.g., cube) depending on the granularity of the coordinate space (e.g., a tesseract based coordinate space 200), e.g., as described for FIG. 3 or otherwise herein. In the example of FIG. 5, sub-voxel 4083Dp, which may comprise a more granular voxel or otherwise point of voxel 4083D of FIG. 4, may comprise a portion of a set of voxels within tesseract based coordinate space 200, which as a group, defines the shape of vehicle 500. For example, in one aspect vehicle 500 is illustrated as 2 centimeters cubes (e.g., xyz.xyz.xyz.xyz.xyz.xyz.xyz. xyz.xyz (9 degrees of cubes) as described and shown for FIG. 4). In addition, further detail, e.g., at the 2 millimeters, may be accomplished by configuring or specifying that the coordinate space (e.g., a tesseract based coordinate space 200) have an additional granularity setting, e.g., at one more cube set, e.g., xyz.xyz.xyz.xyz.xyz.xyz.xyz.xyz.xyz.xyz (10 degrees of cubes) as described and shown for FIG. 4. Such flexibility allows the cubes to scale to very small points or locations to provide for extreme precision. For example, where the granularity setting is 2 mm with 10 degrees of cubes (i.e., xyz.xyz.xyz.xyz.xyz.xyz.xyz.xyz.xyz.xyz), such setting can used for directed energy (DE) applications, including military use cases (e.g., locationing, tracking, and targeting) and medical uses cases (e.g., radiation treatments and eye surgery).

In various aspects, as the vehicle 500 moves within the real-world, the set of voxels that make up the vehicle 500 (and therefore define its position) at a first time period may change. For example, at least a subset of voxels within tesseract based coordinate space 200, and previously identified as having a position data relative to the car's position or location during the first time period, may no longer map to the vehicle 500. Instead, at a second time period, the vehicle (and therefore its position) may have moved to and/or map to a new set of voxels, and the new set of voxels within coordinate space 200 (e.g., a tesseract-based space) may be updated with the vehicle 500′s new location and/or position. In this manner the vehicle 500 can be tracked based on the voxels that make up the coordinate space 200 (e.g., a tesseract-based space), and the vehicle 500, relative to all other objects or data within coordinate space 200 (e.g., a tesseract-based space), can be monitored, positioned, tracked, and/or otherwise be identified, including over one or more time periods (e.g., in real-time or near real-time).

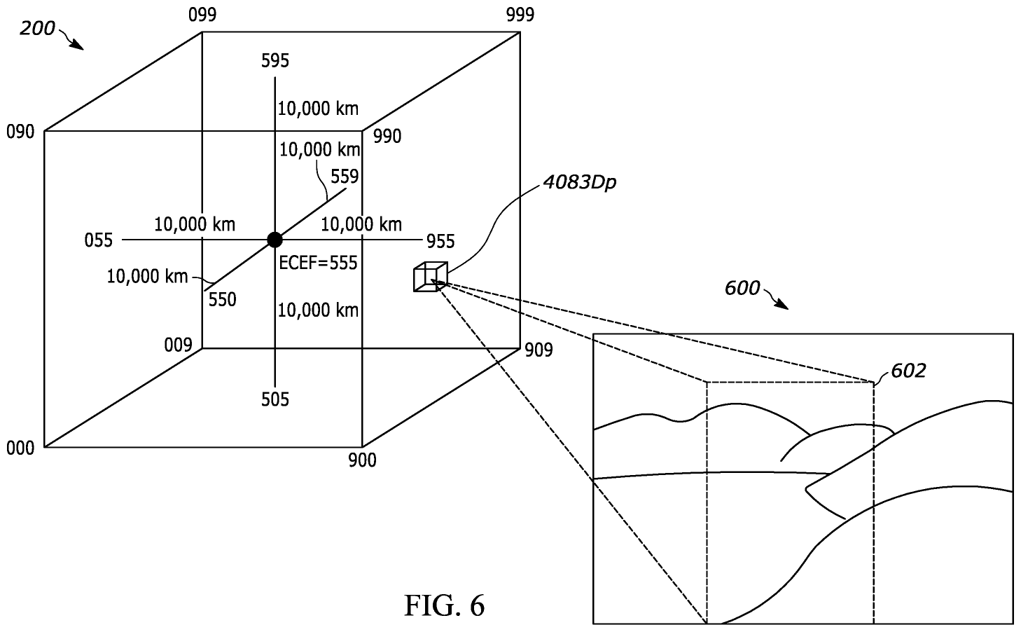

Illustrates an example aspect of positioning and locationing within the coordinate space 200 (e.g., a tesseract-based space) of FIG. 2 based on two-dimensional (2D) images captured in the real-world, in accordance with various embodiments disclosed herein. In such aspects, 2D image capture may be used to provide data to the coordinate space 200. In the example of FIG. 6, 2D image-based positioning and locationing is possible by locating where a given 2D image or picture was taken or was captured. This may comprise conducting a 360-degree scan, and aligning the features and edges of the image to a known voxel based space or otherwise library, e.g., coordinate space 200 (e.g., a tesseract-based space) of FIG. 2.

For example, as shown for FIG. 6, an image 602 of a geographical location or scene 600 may be captured by a digital camera or image sensor. As shown, in some aspects, the image 602 may be part of a larger or overall geographical location or scene 600. Image 602 is comprised of various pixels and may have a certain image resolution, which may be defined in pixels per inch (PPI). A PPI value defines how many pixels are within a given inch of an image. Higher resolutions have more pixels per inch (PPI) than lower resolution, where higher PPI based images have in more pixel information than lower PPI based images. In various aspects, the PPI value of the image 602 may be used as a relative value to determine distances within coordinate space 200 (e.g., a tesseract-based space). For example, based on the PPI value, and relative scaling of the pixels with image 602 (based on the number of horizontal and/or vertical pixels), a position from known-point within coordinate space 200 (e.g., a tesseract-based space) may be determined. For example, in some aspects the known-point may comprise ECEF mid-point at value 555 (on a scale 000-999 as defined each of the three dimensions as shown for FIG. 2). In other aspects, the known-point may comprise sub-voxel 4083Dp, which is a more granular voxel or otherwise point of voxel 4083D of FIG. 4) having a location within a coordinate space 200 (e.g., a tesseract-based space). For example, sub-voxel 4083Dp may comprise information or data regarding the location of vehicle 500. From the location of vehicle 500, the position at which image 602 may be determined, e.g., based on analysis of the pixels of image 602. Such analysis may comprise applying or comparing a known scaled distance determined for image 602 (as determined by the number of pixels and/or PPI value of image 602) to an actual distance as measured or known for coordinate space 200 (e.g., a tesseract-based space). For example, the distance (e.g., in millimeters or centimeters) may be determined first for the image 602, and then such distance may be scaled up or otherwise extrapolated (e.g., to meters or kilometers) using the measured or known distance for coordinate space 200 (e.g., a tesseract-based space) to determine a real-world distance. Using the distance information, a position or location (e.g., in latitude, longitude, and/or north-south, e.g., XYZ coordinate) may be determined for where the image 602 was captured. The position or location may then be updated for one or more shapes (e.g., cubes) of the coordinate space 200 (e.g., a tesseract-based space), where the coordinate space 200 (e.g., a tesseract-based space) as a whole gains additional information as captured for the image 602. Additional information of image 602 may likewise be added for the coordinate space 200 (e.g., a tesseract-based space), where, for example, information or data regarding the topography, geographic features (e.g., rivers, lakes, roads, vehicles, etc.) as identified within the image 602 may be added to the coordinate space 200 (e.g., a tesseract-based space). In addition, a time value or timestamp at which image 602 was captured may also be added for the coordinate space 200 (e.g., a tesseract-based space). In various aspects, data or information added for the coordinate space 200 (e.g., a tesseract-based space) is added in a computer memory or database for later access as described herein.

In various aspects, such 2D image-based positioning and locationing is especially useful in GPS denied areas or areas of operation, e.g., requiring navigation, locationing, or the like, because such positing is not dependent on GPS provided data.

### EXAMPLE USE CASES

In one use case, the virtual and real-world positioning and locationing systems and methods, as described by the Figures and elsewhere herein, may generate and access coordinate space 200 (e.g., a tesseract-based space), for example, for geospatial data analysis, visualization, and/or risk mitigation. In some aspects, the virtual and real-world positioning and locationing systems and methods, as described herein, may be configured to analyze and describe an operational environment (OE) in accordance with coordinate space 200 (e.g., a tesseract-based space). The OE complexity may be determined based on the granularity or otherwise number of shapes (e.g., cubes) of the in terms of the coordinate space 200 (e.g., a tesseract-based space). In some aspects, machine learning (ML) and/or artificial intelligence (AI) models may be trained using locationing and/or positioning data as input into an ML or AI algorithm for feature as in order to train an AI or ML model to provide predictions corresponding to identification or attributes of shapes (e.g., cubes) within the coordinate space 200 (e.g., a tesseract-based space). Once trained, the machine learning (ML) and/or artificial intelligence (AI) models may provide outputs predictions or classifying objects (based on one or more shapes) and related activity within the coordinate space 200 (e.g., a tesseract-based space). Such predictions and/or classifications may include, for example, one or more observations corresponding to shapes (or related objects) within coordinate space 200 (e.g., a tesseract-based), which may include the detection of regularities or irregularities in an OE. Additionally, or alternatively, in some aspects the virtual and real-world positioning and locationing systems an output prediction may comprise a suggestion or alteration to produce a desired outcome within the OE, e.g., where an output could cause a real-world or virtual device or instrument to affect assets, targets, or objects in the coordinate space 200 (e.g., a tesseract-based space) or otherwise OE. Additionally, or alternatively, in some aspects the prediction output provides information, such as a situational awareness, of a given activity, event, or situation within the coordinate space 200 (e.g., a tesseract-based space) or otherwise OE, and provides a suggestion or alteration to modify or update the activity, event, or situation within the coordinate space 200 (e.g., a tesseract-based space) or otherwise OE.

In another use case, the virtual and real-world positioning and locationing systems and methods, as described by the Figures and elsewhere herein, may generate and access coordinate space 200 (e.g., a tesseract-based space), for example, for proliferating low orbit positioning, navigation, and timing. The virtual and real-world positioning and locationing systems and methods, as described herein, may be configured to provide navigation in the Low Earth Orbit (LEO) satellite space without using GPS. In such aspects, data from non-GPS input sources may be added to one or more shapes of the coordinate space 200 (e.g., a tesseract-based space). The coordinate space 200 (e.g., a tesseract-based space) be may be accessed, e.g., by processor 104, to provide positioning and precise timing with a positioning accuracy of less than 50 meters 3-D (Spherical) Position (95%), less than 6 meters/second velocity error (RMS per axis), and less than 50 nanosecond time transfer (95%) (threshold). In other aspects, such parameters may comprise less than 10 meters, less than 3 meters/second, and less than 20 nanosecond time transfer.

In another use case, the virtual and real-world positioning and locationing systems and methods, as described by the Figures and elsewhere herein, may generate and access coordinate space 200 (e.g., a tesseract-based space), for example, for navigation in GPS denied environments. The virtual and real-world positioning and locationing systems and methods, as described herein, may be configured to provide locating, positioning, and/or navigation related data to objects traveling within the coordinate space 200 (e.g., a tesseract-based space) where GPS is unavailable.

In another use case, the virtual and real-world positioning and locationing systems and methods, as described by the Figures and elsewhere herein, may generate and access coordinate space 200 (e.g., a tesseract-based space), for example, for virtual reality (VR) and/or augmented reality (AR) implementations. For example, the virtual and real-world positioning and locationing systems and methods, as described herein, may be configured to access coordinate space 200 in order to provide accurate locationing, positioning, and temporal data for AR/VR systems. For example, a user interacting with an AR/VR device, e.g., a VR headset, may view the coordinate space 200 (e.g., a tesseract-based space) or an environment based on the coordinate space 200 (e.g., a tesseract-based space) via a display of the AR/VR device, and, in some aspects may interact with objects within the coordinate space 200 or environment.

In another use case, the virtual and real-world positioning and locationing systems and methods, as described by the Figures and elsewhere herein, may generate and access coordinate space 200 (e.g., a tesseract-based space), for example, for deduplication of large datasets as ingested from multiple sources in real time. The virtual and real-world positioning and locationing systems and methods, as described herein, may be configured to ingest or otherwise receive data or datasets from multiple input sources (e.g., in real time and/or near real time). In addition, one or more of the shape s (e.g., cubes) of the coordinate space 200 (e.g., a tesseract-based space) may be assigned or otherwise associated with the data, where the shape (e.g., cube) has a location or position coordinate associated with the data at a given time. In this way, the data or datasets are instantiated with metadata, which may come from multiple sources, and which may be reduced into, or otherwise associated with, a given shape or cube. In some cases, a single cube may receive information or data from multiple sources. In some aspects, the sources or data may be redundant, and, in such aspects, the real-world positioning and locationing systems may reduce, coordinate, or normalize the data for the data to be assigned to the given shape (e.g., cube) so that data may be stored for the shape in the coordinate space 200 (e.g., a tesseract-based space) as non-redundant. The data may then be accessed by, e.g., a processor, of the virtual and real-world positioning and locationing systems and methods where the data received will be high fidelity or high quality because the processor would have previously deduplicated, reduced, normalized, and/or otherwise fileted, cleaned, and/or otherwise preprocessed the data before being storing or adding it to the coordinate space 200 (e.g., a tesseract-based space).

### ADDITIONAL CONSIDERATIONS

Although the disclosure herein sets forth a detailed description of numerous different embodiments, it should be understood that the legal scope of the description is defined by the words of the aspects set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the aspects herein.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at Icast partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent aspects at the end of this patent application are not intended to be construed under 35 U.S.C. § 112(f) unless traditional means-plus-function language is expressly recited, such as “means for” or “step for” language being explicitly recited in the aspects herein. The systems and methods described herein are directed to an improvement to computer functionality, and improve the functioning of conventional computers.

1. A computing system configured to generate shape-related data for positioning and locationing of shapes within a coordinate space, the computer system comprising:
a controller;
a memory; and
a database communicatively coupled to the controller,
wherein the memory stores computing instructions that when executed by the controller, causes the controller to:
generate or determine locating or positioning data of a shape or voxel, the shape or voxel having a location derived from or assigned to a location or position within a coordinate space, and the shape or voxel location being derived from, or being based on, a point of origin of the coordinate space,
wherein the location of the shape or voxel is determined by a confidence or range configured for a plurality of shapes or voxels of the coordinate space, and the confidence or range is based on a size and/or number of shapes and/or voxels for the coordinate space.

2. The computing system of claim 1, wherein the locating or position data comprises latitude information or longitude information.

3. The computing system of claim 1, wherein the coordinate space is a tesseract-based space.

4. The computing system of claim 1, wherein the point of origin is a point having a three-dimensional (3D) value of 000 corresponding to a centered XYZ position in the coordinate space.

5. The computing system of claim 1, wherein the point of origin is a point having a ECEF value of 555 corresponding to a centered ECEF position in the coordinate space.

6. The computing system of claim 1, wherein the size and/or number of shapes and/or voxels comprises a size and/or number of cube-based shapes that may include varied or uniform sizes.

7. The computing system of claim 1, wherein the coordinate space has a smallest size cube of 2 millimeters (mm).

8. The computing system of claim 1, wherein the confidence or range has a granularity setting of 10 degrees of cubes.

9. The computing system of claim 8, wherein each cube is defined in the coordinate space with a locationing and positioning format of xyz.xyz.xyz.xyz.xyz.xyz.xyz.xyz.xyz.xyz.

10. A computer-implemented method for generating database reference location information, the computer-implemented method comprising:
storing information assigned to a defined shape having a location within a coordinate space, the defined shape further defined by a cluster of a plurality of sub-shapes configured to scale to fit a perimeter or outline of the defined shape; and
assigning a timestamp to the defined shape and/or one or more of the sub-shapes across one or more periods of time associated with a fourth dimension of the coordinate space.

11. The computer-implemented method of claim 10, wherein the coordinate space is a tesseract-based space.

12. A computer-implemented method for storing and retrieving data in a computer memory referenced location, the computer-implemented method comprising:
receiving input data from a sensor or other data source comprising location or positioning information;
storing the locating or positioning information in a database;
mapping the locating or positioning information to a four-dimensional coordinate space,
wherein the locating or positioning information is mapped relative to a point of origin and/or earth center, earth fixed point of the four-dimensional coordinate space.

13. The computer-implemented method of claim 12, wherein the four-dimensional coordinate space is a tesseract-based space.

14. A tangible, non-transitory computer-readable medium storing instructions for generating location specific data, that when executed by one or more processors cause the one or more processors to:
translate or assign input data having a location, timestamp, and/or other attributes to a shape located within a four-dimensional coordinate space.

15. The tangible, non-transitory computer-readable medium of claim 14, wherein the four-dimensional coordinate space is a tesseract-based space.
